(19) United States
(12) Patent Application Publication
(10) Pub. No.: US 2002/0026252 A1
(43) Pub. Date: Feb. 28, 2002

(54) Computer system for vehicle battery selection based on vehicle operating conditions

(76) Inventors: William J. Wruck, Whitefish Bay, WI (US); Ronald C. Miles, Whitefish Bay, WI (US); Ralph A. Petersen, West Allis, WI (US); Arlen P. Walker, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 09/858,175

(22) Filed: May 15, 2001

Related U.S. Application Data
(60) Provisional application No. 60/204,257, filed on May 15, 2000.

(51) Int. Cl. G06F 17/00

(52) U.S. Cl. 700/90; 707/102; 700/236

(57) ABSTRACT

A computer system for vehicle battery selection based on vehicle operating conditions is disclosed. The computer system allows a user to obtain a prediction of vehicle battery service life when the user inputs a battery, a vehicle in which the battery will be installed and driving habits, and a geographic region in which the vehicle will be operated.

### CROSS REFERENCE TO RELATED APPLICATIONS

This application claims the benefit of U.S. Provisional Application 60/204,257 filed May 15, 2000.

### BACKGROUND OF THE INVENTION

1. Field of the Invention

This invention relates to a computer system for vehicle battery selection based on vehicle operating conditions, and more particularly to a computer system that allows a user to obtain a prediction of vehicle battery service life when the user inputs a battery, a vehicle in which the battery will be installed and driving habits, and a geographic region in which the vehicle will be operated.

2. Description of the Related Art

It is well known that the capability of a storage battery (such as a lead-acid battery) to function is limited to a certain time period often called the operating or service life. When the storage battery is unable to achieve predetermined required performance criteria, operating life of the battery has ended, and it is said that the battery has reached “end-of-life”. The criteria used to determine when the end-of-life has been reached can vary widely; however, it is generally agreed that the failure, i.e., the end-of-life, of a battery is caused by one of two failure modes: (1) catastrophic battery failure, and (2) progressive battery failure.

In catastrophic battery failure, there is a sudden complete inability of the battery to function. When a storage battery fails in this failure mode, the end-of-life for the battery is easily detected, i.e., the battery simply will not function. Catastrophic battery failure is generally the result of poor quality control during battery manufacture or abuse by the battery user.

In progressive battery failure, there is a slow decrease in the discharge capacity of the battery to some lower limit. In most instances, storage batteries fail in this mode, and the end-of-life for the battery is determined when the battery capacity has declined to an unacceptable level. In this failure mode, the decision that the end-of-life has been reached depends on an arbitrary determination of what is an unacceptable level of battery capacity. For instance, when lead-acid batteries are used in automobile starting applications, the battery capacity has reached an unacceptable level when the battery is unable to start the automobile engine. In laboratory settings, a storage battery has reached end-of-life when the battery does not meet certain predetermined capacity measurements when tested under specified load conditions.

While catastrophic battery failure can generally be avoided by manufacturing quality control and maintenance by the end user, progressive battery failure is an inevitable occurrence that cannot be avoided. Therefore, the causes of progressive battery failure have been investigated extensively in an effort to determine which variables can be controlled to extend storage battery operating life.

While numerous parameters have an effect on when end-of-life occurs in a progressive battery failure mode, it has been reported that progressive failure generally depends on manufacturing variables and battery operating conditions. For example, in lead-acid batteries, manufacturing variables (such as the chemical composition and physical properties of the lead oxide used to form the battery paste, the composition of the paste, the composition of the formed plates, the plate thickness, the composition and physical properties of the grids, the composition of the electrolyte, and the separator design) and service conditions (such as storage time before use, charge/discharge conditions, and temperature) will act to cause failure of the storage battery.

Studies of the variables that effect failure in lead-acid batteries have also identified typical failure mechanisms in a lead-acid battery. Major failure mechanisms include: positive paste shedding, positive grid corrosion, positive grid growth, negative paste shrinkage, water loss, and separator degradation. These failure mechanisms have been widely studied and are explained in detail in Bode, Lead-Acid Batteries, John Wiley & Sons, 1977, pages 322-349, and Rand et al., Batteries for Electric Vehicles, SAE International, 1998, pages 199-209.

Studies of the failure modes of 12-volt automotive passenger car lead-acid batteries have also provided a clearer understanding of when end-of-life occurs in lead-acid batteries. For example, the Battery Council International has periodically prepared and published a study of failure modes in car batteries. One failure mode study is reported by Hoover at “Failure Modes of Batteries Removed from Service”, Battery Council International 107^{th} Convention Proceedings, pages 62-66, 1995. In this study, over 3100 junked lead acid batteries were collected by 11 battery manufacturers and analyzed for failure mode. The study collected data on the service life of the batteries and provided an average time in service for the batteries. The study also provided an analysis of average time in service for batteries used in different geographic regions of the United States. The average mean temperature for each geographic region was calculated and the average time in service (in months) was plotted versus annual mean temperature. This data analysis showed that there is a good correlation between average mean temperature and battery life in months, i.e., increasing average mean temperature correlates with decreasing battery life.

It can be appreciated from the foregoing that the storage battery industry has made great strides in understanding progressive failure in batteries. In particular, the lead-acid battery industry has isolated many of the variables that effect battery operating life, has uncovered the primary mechanisms that cause progressive battery failure, and has documented the expected service life of lead-acid batteries used in automotive applications. However, it is believed that the lead-acid battery industry has not developed this battery life knowledge further such that an automobile battery consumer, such as a car manufacturer or an automobile owner replacing a worn out battery, can select an automobile battery that will have a service life tailored to their specific automobile, driving habits, geographic region and operating life expectancy.

For example, automobile manufacturers have been under increased consumer pressure to extend the term of automobile warranties. As a result, automakers have requested increased product life from all suppliers of original equipment parts. In the automobile battery field, the increased battery operating life requirements can be troublesome for battery manufacturers as all automobile batteries will eventually fail as explained above. Therefore, the battery manufacturer is often faced with the problem of supplying a battery that meets a satisfactory service life for the vehicle. In addition, because of reduced under-the-hood air flow in certain vehicles, a battery may experience adverse operating temperatures that reduce battery service life. It can be appreciated that the business relationship between an automobile battery manufacturer and an automobile manufacturer could be strengthened by a system where an automobile manufacturer could select an automobile battery that would have a maximum operating life for the particular vehicle. The proper selection of an original equipment battery would limit warranty claims and at the same time would allow the automobile manufacturer to avoid selecting a more expensive, larger capacity battery in the hopes of achieving longer life.

An automobile owner that is replacing a battery could also benefit from a system that allows for selection of an automobile battery that would meet the consumer's operating life requirements. For example, the automobile owner may intend to sell a car in two years and therefore it would be in the economic interest of the automobile owner to purchase a lower cost battery with a shorter operating life expectancy. Similarly, an automobile owner intending on keeping an auto for five years may prefer a costlier battery that will last five years.

Therefore, it can be seen that there is a need for a system that would allow an automobile manufacturer or an automobile owner to select an automobile battery that will meet their requirements for battery service life. More particularly, there is a need for a system that will accept information on vehicle type, vehicle operating conditions, and battery selection, and will provide a user (e.g., an automaker or auto owner) with an operating life expectancy for the battery selected. With this system, an automaker or auto owner can compare the life expectancies of various batteries and can select a battery (or batteries) that will meet a predetermined life expectancy.

### SUMMARY OF THE INVENTION

The foregoing needs are met by a computer system for vehicle battery selection that allows a user to obtain a prediction of vehicle battery service life when the user inputs into the computer system: a battery, a vehicle in which the battery will be installed and driving habits, and a geographic region in which the vehicle will be operated. The computer system broadly comprises: (1) a data entry system wherein a user inputs data regarding (i) vehicle battery selection, (ii) the vehicle in which the battery will be installed and driving habits, and (iii) a geographic region in which the vehicle will be operated; (2) a computer fixed storage unit which stores: (i) data on the battery selected during data input, (ii) data on the climate in the geographic region selected during data input, (iii) data on the vehicle selected during data input including vehicle drive pattern data, and (iv) a battery life prediction algorithm; and (3) a computer central processing unit that uses the battery life prediction algorithm to predict the end of life for a battery using the input data from the data acquisition system and the data stored on the fixed storage unit.

### BRIEF DESCRIPTION OF THE DRAWINGS

The features, aspects, objects, and advantages of the present invention will become better understood upon consideration of the following detailed description, appended claims and accompanying drawings where:

FIG. 1 is a representation of a typical on-line environment in which the battery life predictor computer system of the present invention can be practiced;

FIG. 1A is representation of a client or server suitable for use in the on-line environment of FIG. 1;

FIG. 2 is a flow diagram of a process for obtaining a vehicle battery service life prediction using the on-line environment of FIG. 1;

FIG. 3 is an input screen used for data acquisition before obtaining a vehicle battery service life prediction using the on-line environment of FIG. 1;

FIG. 4 is another input screen used for data acquisition before obtaining a vehicle battery service life prediction using the on-line environment of FIG. 1;

FIG. 5 is yet another input screen used for data acquisition before obtaining a vehicle battery service life prediction using the on-line environment of FIG. 1;

FIG. 6 is an output screen that displays a vehicle battery service life prediction obtained using the on-line environment of FIG. 1;

FIG. 7 is a representation of another typical on-line environment in which the battery life predictor computer system of the present invention can be practiced;

FIG. 8 is representation of a client or server suitable for use in the on-line environment of FIG. 7;

FIG. 9 is a flow diagram of a process for obtaining a vehicle battery service life prediction using the on-line environment of FIG. 7;

FIG. 10 illustrates a data structure used to store vehicle battery data for each battery for which a battery end-of-life prediction can be calculated using a battery life prediction algorithm;

FIG. 11 illustrates a data structure used to store vehicle data for each vehicle for which a battery end-of-life prediction can be calculated using a battery life prediction algorithm;

FIG. 12 is a plot of battery temperature versus time for a vehicle for which a battery end-of-life prediction can be calculated when the vehicle is driven according to an average driver profile;

FIG. 13 is a plot of battery temperature versus time for a vehicle for which a battery end-of-life prediction can be calculated when the vehicle is driven according to an severe driver profile;

FIG. 14 illustrates a data structure used to store geographic region data for each geographic region for which a battery end-of-life prediction can be calculated using a battery life prediction algorithm; and

FIG. 15 is a flow diagram showing the steps that can be used to develop a battery life prediction algorithm in accordance with the invention.

It should be understood that the invention is not necessarily limited to the particular embodiments illustrated herein.

### DETAILED DESCRIPTION OF THE INVENTION

### I. An Example Environment for Using the Battery Life Predictor

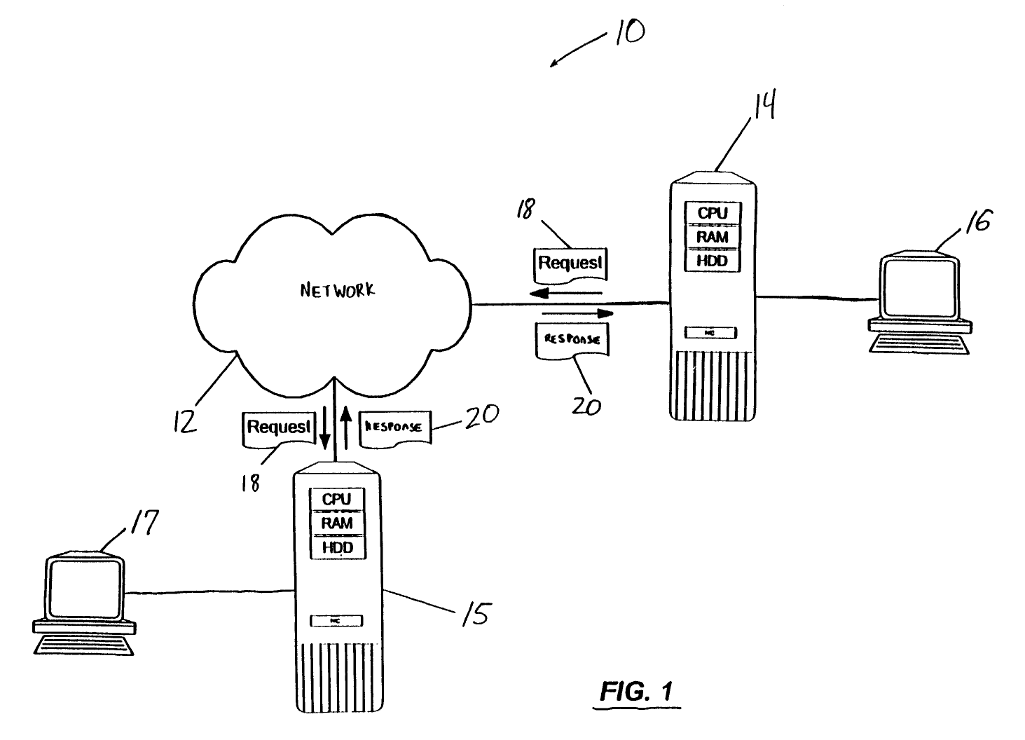

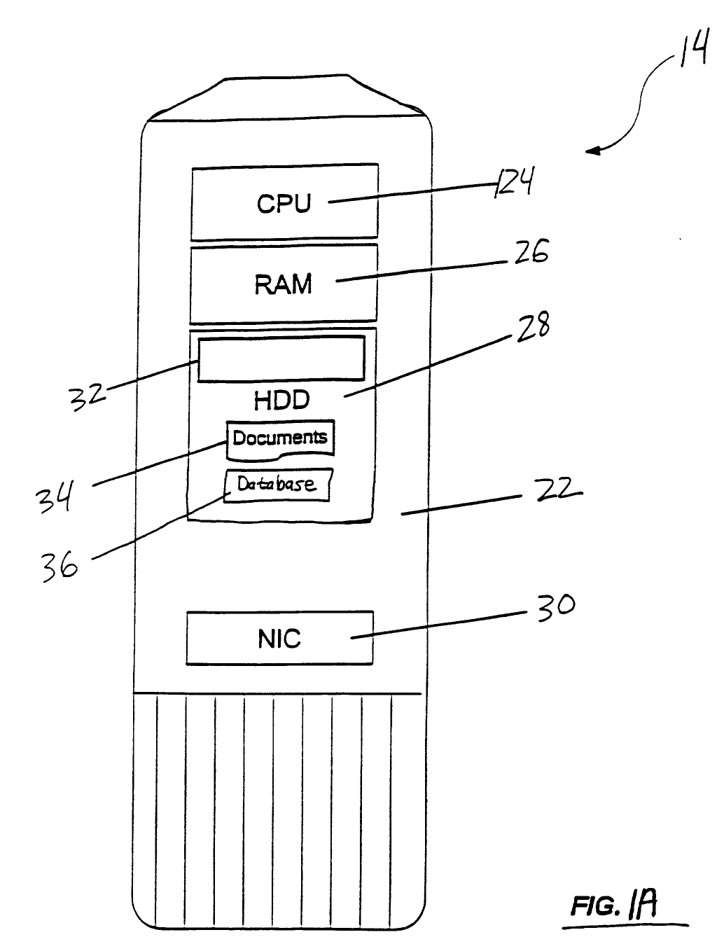

Referring now to FIG. 1, a typical on-line environment 10 is illustrated in which the battery life predictor of the present invention can be practiced. This environment 10 comprises a communication network 12 interconnecting a first E-mail server 14 and a second E-mail server 15. The first E-mail server 14 is connected to a first client 16 and the second E-mail server 15 is connected to a second client 17. Typically, the environment 10 could potentially comprise millions of clients 16 and servers 14.

The network 12 can be any non-publically accessible network such as a LAN (local area network) or WAN (wide area network), or preferably, the Internet, and the interconnections between the E-mail servers 14 and 15 can be thought of as virtual circuits that are established between them for the express purpose of communication. Each E-mail server establishes a connection in order to send E-mail messages to the other E-mail servers via the network 12.

As shown now in FIG. 1A, each E-mail server 14 and 15 preferably comprises a computer 22 having therein a central processing unit (CPU) 24, an internal memory device 26 such as a random access memory (RAM), and a fixed storage 28 such as a hard disk drive (HDD). Each server 14 and 15 also includes network interface circuitry (NIC) 30 for communicatively connecting the computer 22 to the network 12. The CPU 24 can comprise any suitable microprocessor or other electronic processing unit, as is well known to those skilled in the art. The various hardware requirements for the computer 22 as described herein can generally be satisfied by any one of many commercially available high speed E-mail servers.

Similar to each E-mail server 14 and 15, each client 16 and 17 also preferably comprises a computer 22 having a CPU 24, an internal memory device 26, fixed storage 28, and network interface circuitry 30, substantially as described above. In addition, the computer 22 of the client 16 comprises an E-mail software program that is preferably stored in the fixed storage 28 and loaded into the internal memory device 26 upon initialization. The E-mail software program permits the clients 16 and 17 to send and receive E-mail to and from the servers 14 and 15.

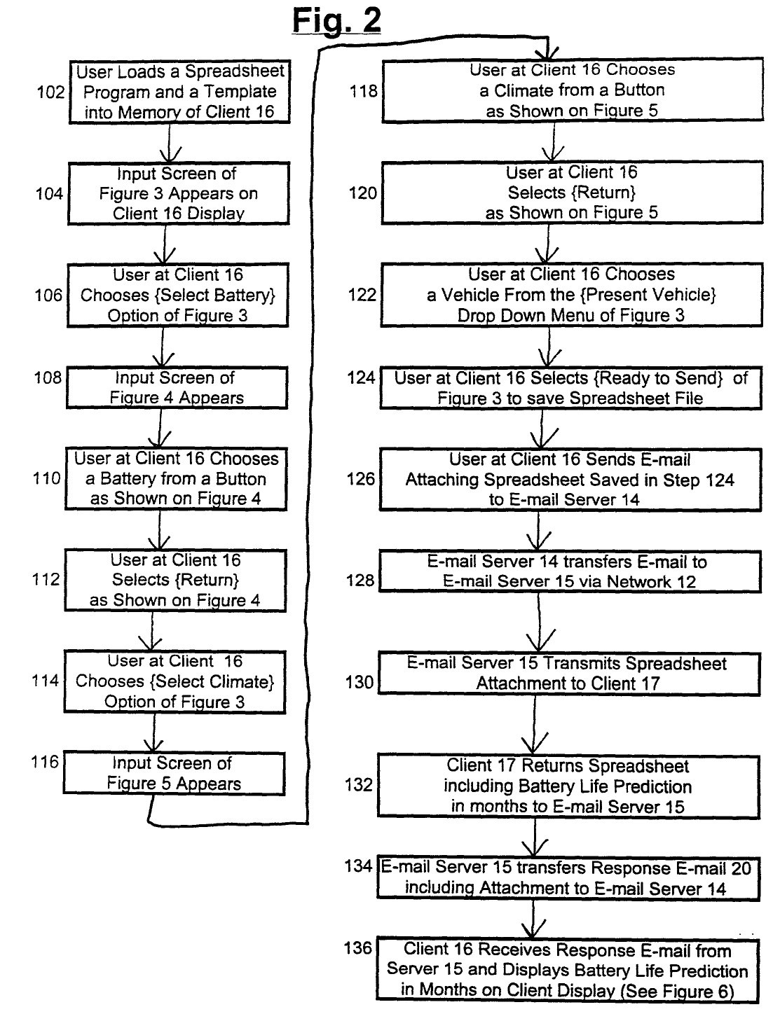

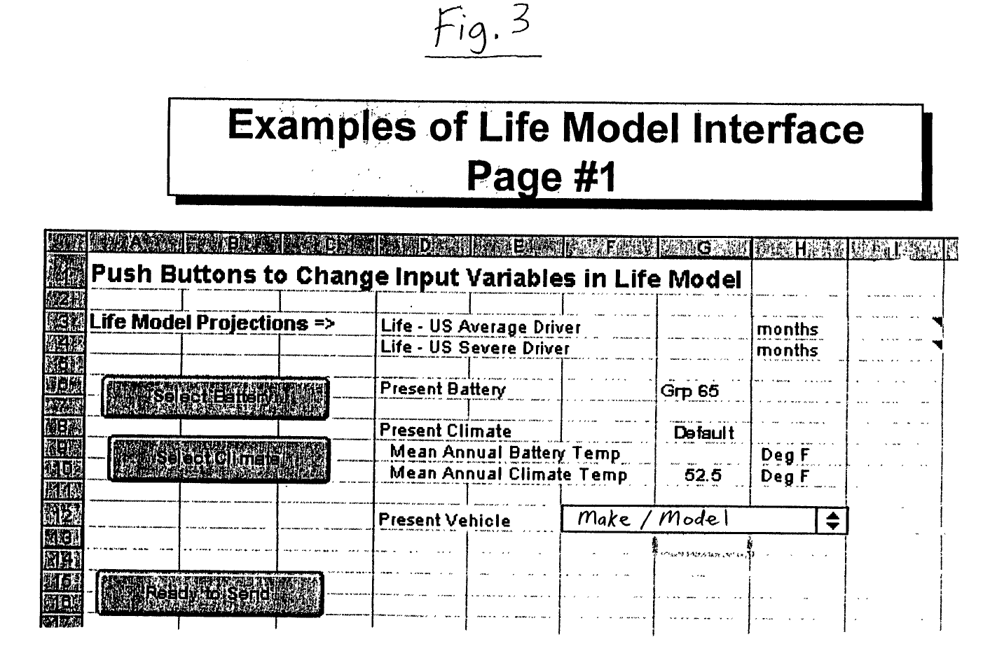

The on-line environment 10 can be used to provide a user with a prediction of battery life as detailed in the flow diagram of FIG. 2. In step 102, a user at client 16 loads a spreadsheet program into the internal memory device 26 of client 16. In one implementation of the invention, the spreadsheet program is a spreadsheet sold under the trademark “EXCEL”. Of course, other spreadsheets would be suitable for use with the invention. The user then uses the spreadsheet program to load a template file into the spreadsheet program. In one implementation of the invention, the template file has a file extension of .xlt, so that the “EXCEL” spreadsheet can recognize the file as a spreadsheet template. After the spreadsheet template is loaded into the spreadsheet program, the input screen of FIG. 3 appears on the display unit of the client 16 as seen from Step

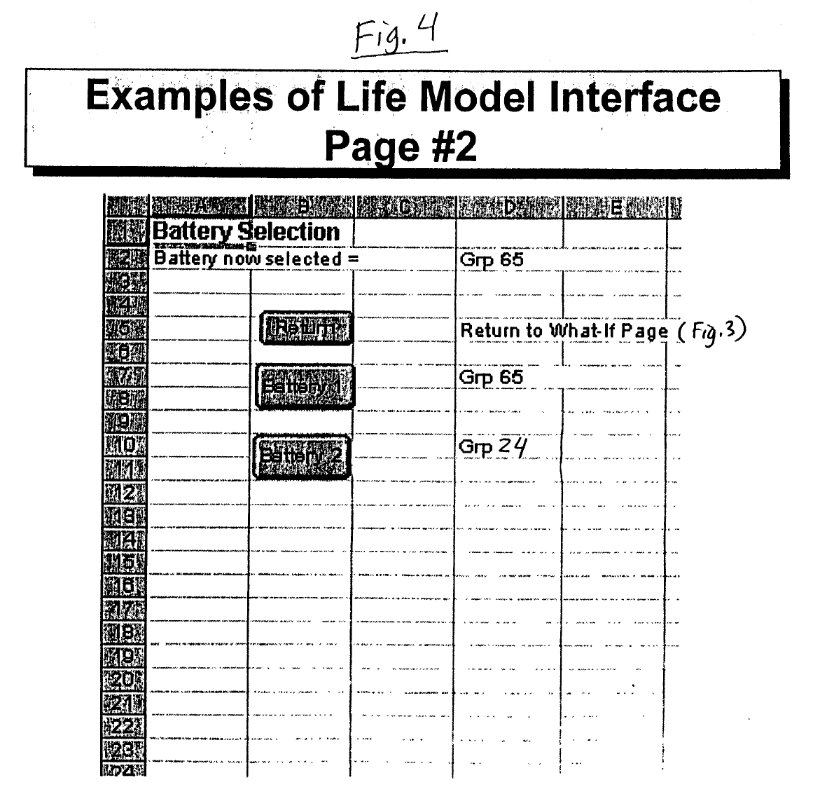

Looking at FIG. 3, it can be seen that the spreadsheet template includes buttons labeled “Select Battery”, “Select Climate” and “Ready to Send”, and a drop down menu entitled “Present Vehicle”. The presently selected Battery, Climate and Vehicle are also displayed, and a location is allocated for the display of battery end-of-life predictions entitled “Life Model Projections”. After the input screen of FIG. 3 appears on the client 16 display, a user at client 16 chooses the “Select Battery” option on the input screen of FIG. 3 at Step 106. The “Select Battery” button is linked to a further input screen, and after choosing “Select Battery”, the input screen of FIG. 4 appears at Step 108. The input screen of FIG. 4 allows a user to choose a battery from a list of batteries. It should be understood that any number of batteries may be listed in the input screen of FIG. 4 and that FIG. 4 merely displays two batteries for the purposes of clarity. At Step 110, the user at client 16 chooses a battery from a button as shown on FIG. 4, and at Step 112, the user at client 16 selects “Return” on FIG. 4 to exit the input screen of FIG. 4 and return to the input screen of FIG. 3. At this time, the user has selected the battery for which a battery life prediction will be calculated.

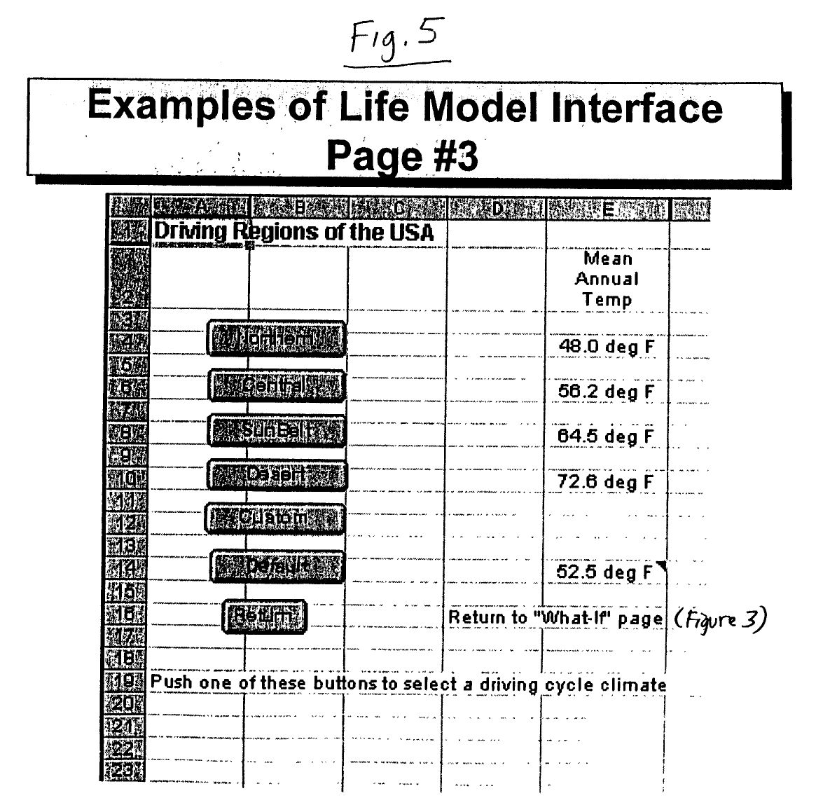

At Step 114, the user at client 16 chooses the “Select Climate” button of FIG. 3. The “Select Climate” button is linked to a further input screen, and after choosing “Select Climate”, the input screen of FIG. 5 appears at Step 116. The input screen of FIG. 5 allows a user to choose a geographic region of the United States where the user will operate a vehicle having the associated battery selected in Step 110. At Step 118, the user at client 16 chooses a climate region from a button as shown on FIG. 5. Alternatively, a custom mean annual temperature may be created by selecting the “Custom” button. In this data entry sequence, the user selects the “Custom” button and is presented with input boxes that ask for the mean temperature during winter, summer, and spring/fall in the “Custom” geographic region. The client 16 can then calculate a mean annual temperature from the input data. At Step 120, the user at client 16 selects “Return” on FIG. 5 to exit the input screen of FIG. 5 and return to the input screen of FIG. 3. At this time, the user has selected the battery for which a battery life prediction will be calculated and the geographic region in which the battery will operate.

At Step 122, the user at client 16 chooses a vehicle from the “Present Vehicle” drop down menu shown in FIG. 3. The vehicle selected should be the specific vehicle in which the battery selected in Step 110 will be installed. Of course, the list of vehicles can be quite long given the number of vehicles available on the new and used car market. After Step 122, the user has selected a battery for which a life prediction will be calculated, a geographic region in which the battery will operate, and a vehicle in which the battery will operate. Having selected the parameters for a battery life prediction, the user is ready to receive a battery life prediction. At Step 124, the user at client 16 selects the “Ready to Send” button of FIG. 3 to receive a dialog box in which the user is prompted for a name in which to save a spreadsheet file having the selected battery, geographic region and vehicle. After completing the dialog box, a file is saved in a standard spreadsheet format. For example, when using an “EXCEL” spreadsheet, a file with an .xls extension is created. It can be appreciated that the selection of battery, climate and vehicle in the on-line environment 110 can be done in any sequence and the flow diagram of FIG. 3 merely illustrates one sequence of a battery, climate and vehicle selection process.

The processing of the spreadsheet file to generate a battery life prediction can be described with reference to FIGS. 1 and 2. At Step 126, the user at client 16 prepares an E-mail message with a specified subject line. For instance, the subject line of the E-mail message may be “Battery 1-Sunbelt-Vehicle 1”. The E-mail also includes a predetermined E-mail destination address that is used for all battery life prediction E-mail. The user then attaches the spreadsheet file created in Steps 102-124 to the E-mail message and as shown at Step 126, the user at client 16 sends the E-mail. In accordance with known methods, the E-mail is transferred at Step 126 to the first E-mail server 14 shown in FIG. 1. At Step 128, the first E-mail server 14 transfers the E-mail message to second E-mail server 15 via the network 12. The E-mail has arrived at the destination address.

At the second E-mail server 15, the incoming E-mail that is addressed to the battery life prediction E-mail destination address is analyzed for the presence of a battery life prediction spreadsheet attachment and the name of an authorized user (i.e., an originating E-mail address that is in a table of authorized E-mail addresses). The check for authorized users is particularly valuable in that E-mail that is received from an unauthorized user is discarded without further processing. If the incoming E-mail includes a battery life prediction spreadsheet attachment and the name of an authorized user, the attachment is analyzed to determine if it was created using an acceptable version of a spreadsheet template. If the attachment was created with an older version of a spreadsheet template that is unacceptable for further processing, a response (reply) E-mail is send to the authorized user in which an acceptable spreadsheet template is attached so that the user may once again begin the process of FIG. 2 at Step 102.

If the incoming E-mail includes an acceptable battery life prediction spreadsheet attachment and the name of an authorized user, the second E-mail server 15 transmits the spreadsheet attachment to the second client 17 at Step 130 for calculation of a battery life. Step 130 proceeds as follows. First, the second E-mail server 15 copies the battery life prediction spreadsheet attachment to a first temporary file with a name such as Input.xls. A semaphore file is also created that will be used by the second E-mail server 15 to determine when processing of the first temporary file is complete. The second E-mail server 15 then launches a spreadsheet program such as “EXCEL” and the first temporary file Input.xls is loaded into a calculation spreadsheet in the spreadsheet program. The calculation spreadsheet includes a battery life prediction algorithm as will be described below. The calculation spreadsheet uses the selected battery, geographic region, and vehicle that are included in the first temporary file Input.xls, and creates a second temporary file with a name such as Results.xls that contains battery life predictions for the battery.

At Step 132, the second client 17 changes the semaphore file to indicate to the second E-mail server 15 that processing of the original E-mail attachment has been completed, and returns the spreadsheet Results.xls, which includes at least one battery life prediction in months, to the second E-mail server 15. The second E-mail server 15 then renames the spreadsheet Results.xls to the name of the original E-mail attachment. The second E-mail server 15 then prepares a response (reply) E-mail 20 that: (1) is addressed to the authorized user who initiated the battery life prediction process, (2) has a subject line reading “Re:

Battery 1-Sunbelt-Vehicle 1” in conformity with the incoming E-mail message subject line, and (3) has an attached completed battery life prediction spreadsheet that was generated by the second client server 17 as described above. If the second E-mail server 15 has detected that the spreadsheet attached to the incoming E-mail was created using an older (albeit acceptable) version of a spreadsheet template, the second E-mail server 15 also attaches a new version of a spreadsheet template to the E-mail and appends a notice regarding the attached new spreadsheet template to the subject line of the E-mail. This new spreadsheet template can be used when the user initiates a new battery prediction process at Step 102. It can be appreciated that by including a new spreadsheet template with the E-mail, the user at client 16 will always have the benefit of the most recent version of the template. This can be quite advantageous in that new batteries and new vehicles are always being produced and then added to the template. In one embodiment of the invention, the processing of the incoming E-mail in Steps 130 and 132 has been implemented using an E-mail software application sold under the trademark “Lotus Notes” and an associated programming language available under the trademark “Lotus Script”.

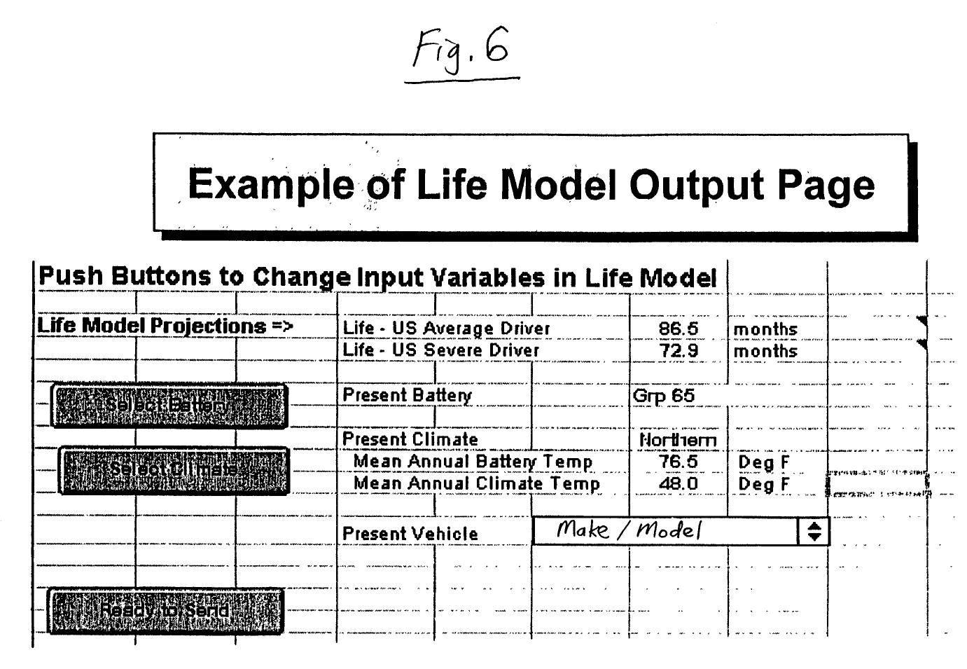

At Step 134, the second E-mail Server 15 transfers the response (reply) E-mail 20 including the completed battery life prediction spreadsheet attachment to E-mail server 14 through the network 12, and at Step 136, the client 16 receives a response (reply) E-mail from the server 15. The reply E-mail has an attached completed battery life prediction spreadsheet that can be displayed on client 16 using a spreadsheet program. FIG. 6 shows an example of a completed battery life prediction spreadsheet that is displayed on the client display. It can be seen that a two battery life predictions in months are displayed next to “Life Model Projections” on the spreadsheet.

### II. Another Example Environment for Using the Battery Life Predictor

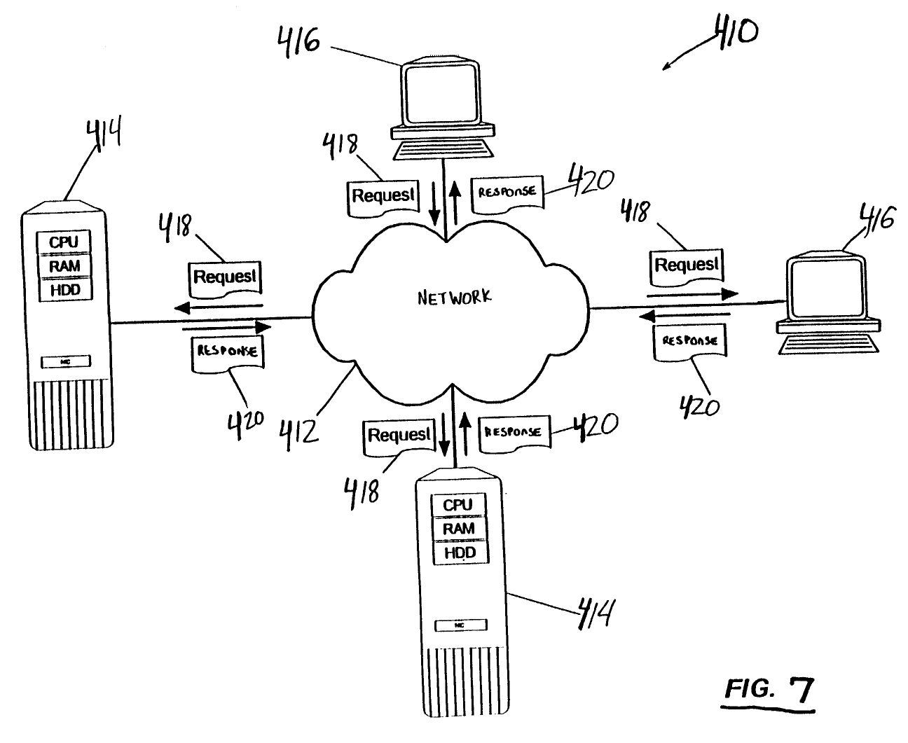

Referring now to FIG. 7, another typical on-line environment 410 is illustrated in which the battery life predictor of the present invention can be practiced. This environment 410 comprises a communication network 412 interconnecting a plurality of servers 414 and a plurality of clients 416, although only a one of the latter is shown for ease of illustration. Typically, however, the environment 410 could potentially comprise millions of clients 416 and servers 414.

The network 412 can be any non-publically accessible network such as a LAN (local area network) or WAN (wide area network), or preferably, the Internet, and the interconnections between the servers 414 and clients 416 can be thought of as virtual circuits that are established between them for the express purpose of communication. Each client 416 establishes a connection in order to send requests 418 for Web pages to the servers 414 via the network 412; each server 414 accepts connections in order to service the requests 418 by sending responses 420 back to the clients 416 via the network 412. Typically, the response will be a document such as a requested Web page.

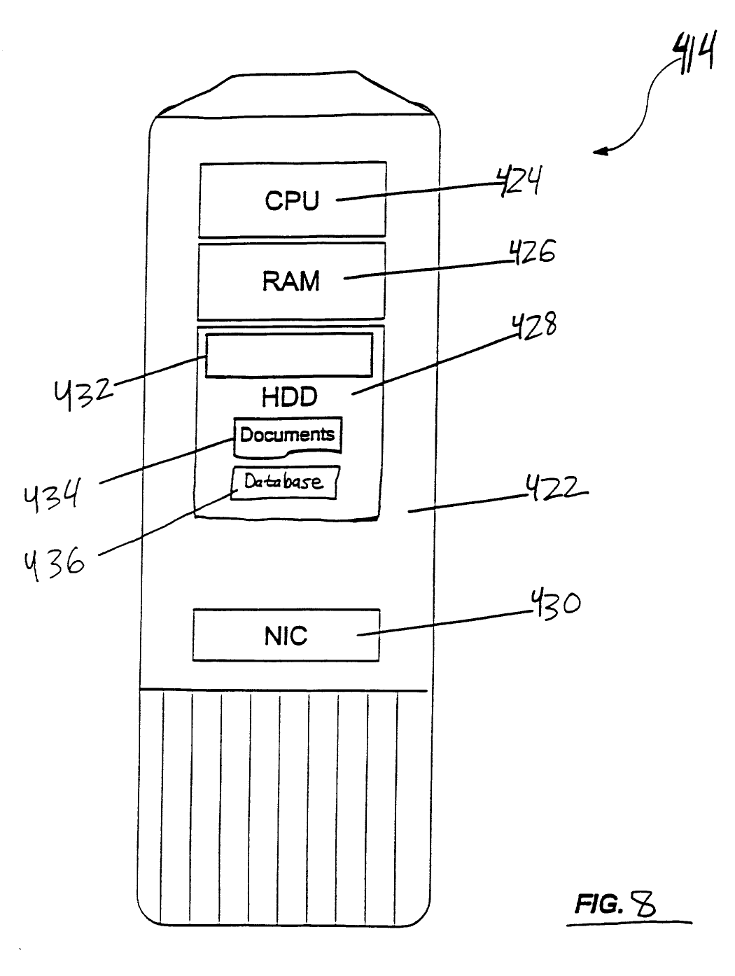

As shown in FIG. 8, each server 414 preferably comprises a computer 422 having therein a central processing unit (CPU) 424, an internal memory device 426 such as a random access memory (RAM), and a fixed storage 428 such as a hard disk drive (HDD). The server 414 also includes network interface circuitry (NIC) 130 for communicatively connecting the computer 422 to the network 412. Optionally, the computer can further include a keyboard (not shown) and at least one user interface display unit (not shown) such as a VDT operatively connected thereto for the purpose of interacting with the computer 422. However, the invention is not limited in this regard. Rather, the computer 422 requires neither a keyboard or a VDT in order to suitably operate according to the inventive arrangements.

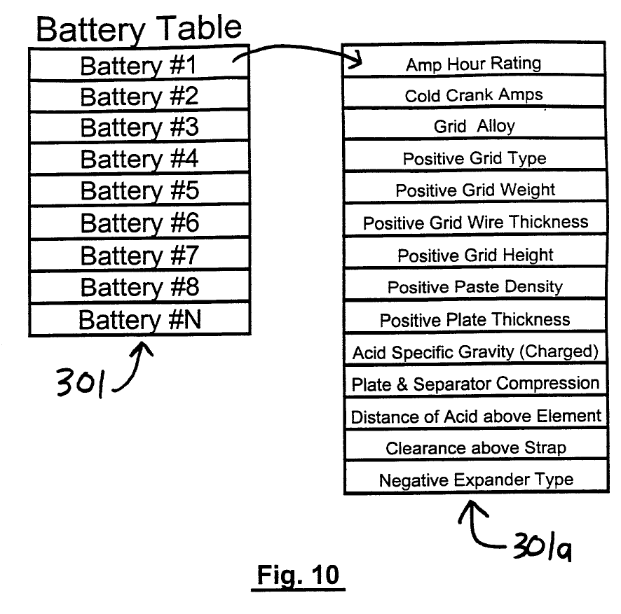

The CPU 424 can comprise any suitable microprocessor or other electronic processing unit, as is well known to those skilled in the art. The various hardware requirements for the computer 422 as described herein can generally be satisfied by any one of many commercially available high speed network servers. The fixed storage 428 can store therein each of an operating system 432, a database 436 for storing battery data such as that shown in FIGS. 10-12, and a hypertext document 434 that defines a plurality of Web pages that will comprise a Web site hosted by the server 414. Upon initialization of the computer 422, the operating system 432 and hypertext document 434 are loaded into the internal memory device 426 for “posting” the hypertext document 434 via the server 414 so that it can be accessed over the network 412 by clients 416. Various Internet Services Providers (ISPs) provide hosting services by connecting to the Internet using standard techniques such as the well-known TCP/IP protocol.

Similar to each server 414, each client 416 also preferably comprises a computer 422 having a CPU 424, an internal memory device 426, fixed storage 428, and network interface circuitry 430, substantially as described above. In addition, the computer 422 of the client 416 comprises a browser software program that is preferably stored in the fixed storage 428 and loaded into the internal memory device 426 upon initialization. The browser permits the client 416 to send and receive the requests 418 to and from the servers 414 via the network 412. In one embodiment, the client 416 sends its requests 418 for the various Web pages to the servers 414 through using the Internet hypertext transfer protocol (HTTP), the application level protocol for distributed, collaborative, and hypertext information systems that has been in use by the Web's global information initiative since approximately 1990. In response to the requests 418, the various Web pages are “served” by the Web servers 414, i.e., posted, allowing the various clients 416 to have access to the requested hypertext documents 434 comprising the site.

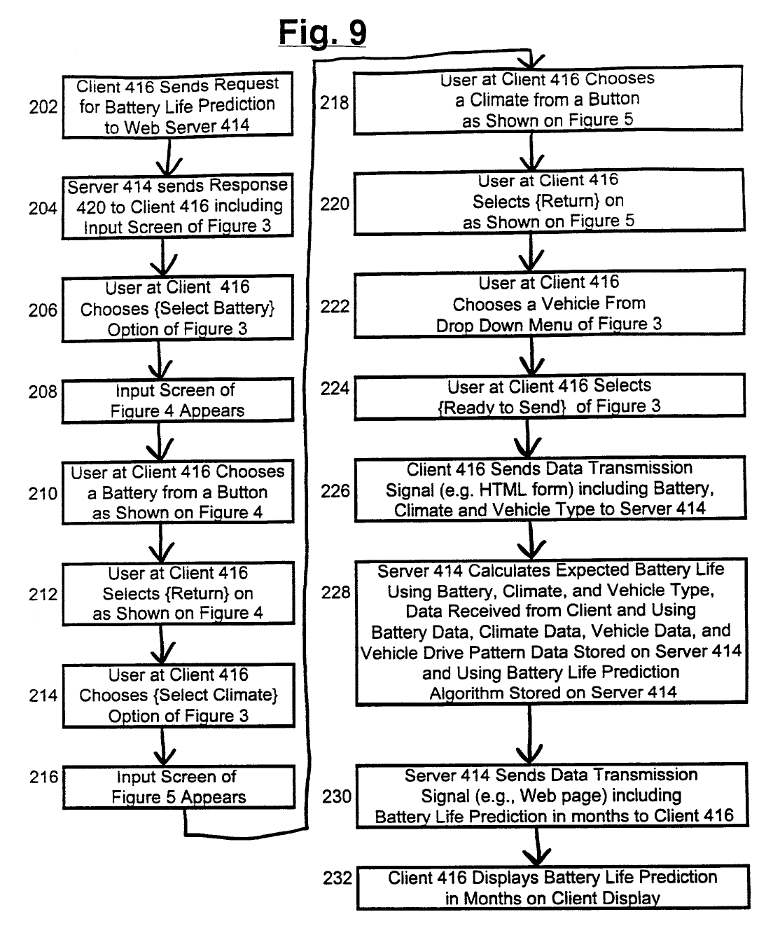

The on-line environment 410 can be used to provide a user with a prediction of battery life as detailed in the flow diagram of FIG. 9. At Step 202, a client 416 sends a request for a Web page having a battery life predictor to a Web server 414 by using the Internet hypertext transfer protocol (HTTP). At step 204, the Web server 414 sends a Web page as a response to the client 416. The Web page can include an input screen as in FIG. 3. At Step 206, the user at client 416 chooses the {Select Battery} option of FIG. 3, and at Step 208, the input screen of FIG. 4 appears. At Step 210, the user at client 416 chooses a battery from a button as shown in FIG. 4, and then the user at client 416 selects {Return} on FIG. 4 at Step 212 to return to the input screen of FIG. 3. At step 214, the user at client 416 chooses the {Select Climate} option of FIG. 3, and at Step 216, the input screen of FIG. 5 appears. At Step 218, the user at client 416 chooses a climate from a button as shown on FIG. 5, then the user at client 416 selects {Return} on FIG. 5 at Step 220 to return to the input screen of FIG. 3. At Step 222, the user at client 416 chooses a vehicle from drop down menu of FIG. 3.

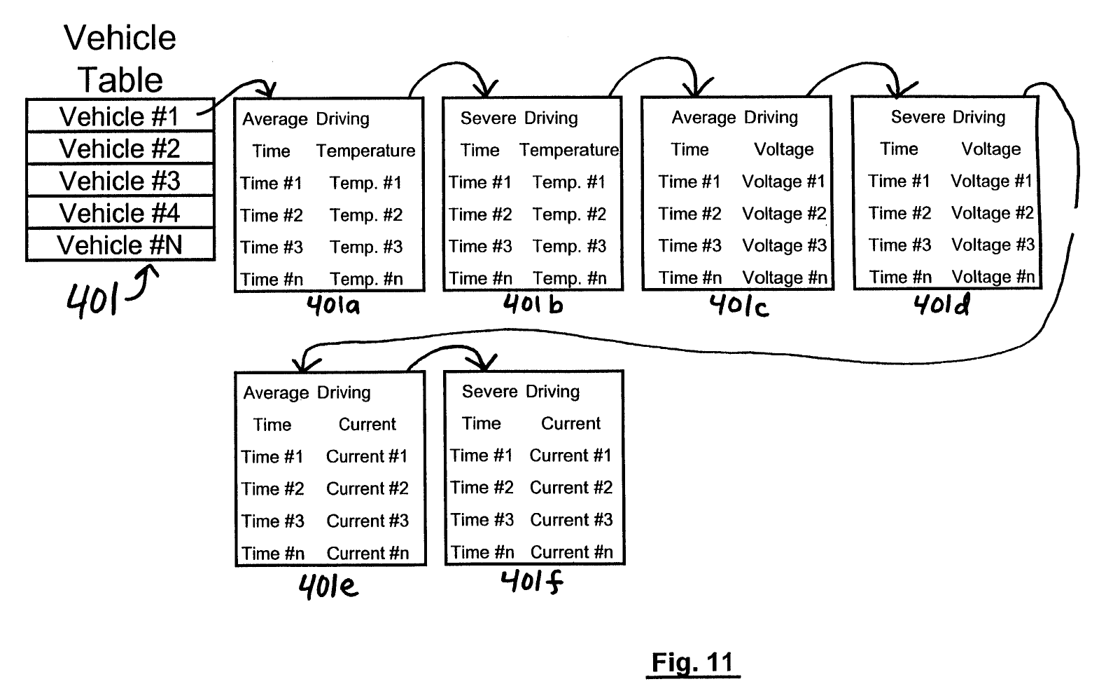

At Step 224. the user at client 416 selects {Ready to Send} of FIG. 3, and the client 416 sends a data transmission signal (i.e., a completed HTML form) including the battery, the climate and the vehicle type to server 414 at Step 226. At Step 228, the server 414 calculates expected battery life using: (i) the battery, climate, and vehicle type data that was received from the client 416, (ii) battery data, climate data, vehicle data, and vehicle drive pattern data stored on the server 414 in data structures such as FIGS. 10, 11 & 14, and (iii) a battery life prediction algorithm stored on the server 414. At Step 230, the Web server sends a data transmission signal (i.e., a Web page) including at least one battery life prediction in months to the client 416, and at Step 232, the client displays the battery life prediction in months on the display of client 416.

In an alternative version of the invention, the Web server 414 at Step 204 sends a different Web page as a response to the client 416. This Web page includes an input screen wherein the {Select Battery} and {Select Climate} buttons are replaced with drop down menus analogous to that used to select the present vehicle. In this version of the invention, the user at client 416 will be able to select the battery, climate and vehicle from a single Web page before sending the response to the Web server 414. It can also be appreciated that the selection of battery, climate and vehicle in the on-line environment 410 can be done in any sequence and the flow diagram of FIG. 9 merely illustrates one sequence of a battery, climate and vehicle selection process.

From the foregoing, it can be appreciated that a battery life prediction could be obtained by any user having access to the Internet or by a user located at a store kiosk that is running a commercially available Internet browser running in kiosk mode. Therefore, the computer system of the present invention when implemented in the on-line environment of FIG. 7, allows an automobile owner replacing a worn out battery to select an automobile battery that will have a service life tailored to their specific automobile, driving habits, geographic region and operating life expectancy.

### III. Battery Life Prediction Algorithm

As detailed above in the above Background section, studies into progressive battery failure in lead-acid batteries have determined that progressive failure generally depends on battery manufacturing variables and battery operating conditions. Therefore, a battery life prediction algorithm that uses battery manufacturing variables and battery operating conditions was developed so that the computer system of the present invention could be used to predict end-of-life for a specific lead-acid battery. The battery life algorithm can be stored in the calculation sheet used in the operating environment of FIGS. 1, 1A and 2, or in the fixed storage server 414 of the operating environment of FIGS. 7-8.

While a number of battery life prediction algorithms are possible, the battery life prediction algorithm used in the present invention predicts lead-acid battery end-of-life as a function of: (1) battery design; (2) vehicle design; (3) vehicle drive habits; and (4) the climate of the geographic region in which the vehicle is operated. An overview of these variables and their use in the battery life prediction algorithm follows.

### A. Variables Used in the Battery Life Prediction Algorithm

### 1. Battery Design Variables

Battery design variables have a significant effect on the service life of a lead-acid battery. For example, it is well known in the lead-acid battery field that a battery having thicker positive grids and plates will generally have a longer operating life. While numerous battery design variables effect lead-acid battery life expectancy, the battery life prediction algorithm used in the computer system of the present invention calculates battery end-of-life using values from the battery lookup table data structure shown in FIG. 10.

It can be seen that the data structure of FIG. 10 includes a battery table 301 with an entry for each battery for which an end-of-life prediction can be calculated using the battery life prediction algorithm. Each entry contains a pointer to a block 301 a containing the battery design variables for the specific battery. The battery table 301 can have an unlimited number of batteries and of course, the table can be periodically updated to include additional batteries. A battery manufacturer using the computer system of the present invention would be able to create the battery table from the manufacturing parameters used to produce the manufacturer's batteries. In addition, a battery manufacturer would be able to include data on a competitor's batteries by purchasing battery evaluation reports that are available to the public. For example, S. E. Ross Laboratories, Inc., an independent testing facility located in Bedford Heights, Ohio, USA, publishes battery evaluation reports that include battery design data for lead-acid batteries made by numerous manufacturers.

When a user selects a specific battery using the on-line environment of FIGS. 1 or 7 as described above, the battery life prediction algorithm locates the specific battery in the battery table 301 and reads the corresponding battery design variables for use in the battery life prediction algorithm.

### 2. Vehicle Design and Vehicle Drive Pattern Variables

It has been determined that different vehicles have different under the hood operating environments. For instance, certain vehicles may experience higher under the hood temperatures because of lower air flow rates into the engine compartment or a smaller sized radiator. It has been discovered that under the hood operating conditions can significantly affect lead-acid battery service life. For example, higher under the hood operating temperatures can lead to decreased battery service life.

It has also been determined that vehicle drive habits affect the under the hood operating environment and therefore, battery service life. For example, long periods of travel usually result in an extended period of elevated temperatures under the hood which can affect battery life. Also, a sequence of frequent engine on and engine off conditions during a day can affect battery life as the under the hood temperature tends to rise after an engine is turned off before tapering off gradually.

Because of the influence that under the hood operating conditions have on battery service life, the battery life prediction algorithm used in the computer system of the present invention calculates battery end-of-life using values from the vehicle lookup table data structure shown in FIG. 11. It can be seen that the data structure includes a vehicle table 401 with an entry for each vehicle for which an end-of-life prediction can be calculated using the battery life prediction algorithm. Each entry contains a pointer to a linked list of blocks 401a-401f containing the vehicle operating condition variables for the specific vehicle. It can be seen that the blocks include battery temperature vs. time, battery voltage vs. time, and battery current vs. time data for an average and a severe driving sequence for each vehicle. The vehicle table 401 can have an unlimited number of vehicles and of course, the vehicle table 401 can be periodically updated to include additional vehicles.

The vehicle table 401 data can be created in a number of ways. In a first method, a vehicle battery can be equipped with electrolyte temperature, battery voltage and battery current monitors that are connected to a data recorder. The vehicle can then be driven through a variety of drive sequences and the battery temperature, voltage and current can be recorded during the drive sequence. The temperature, voltage and current data can then be used to create the data structure shown in FIG. 11. Looking at FIG. 11, it can be seen that in drive testing, Vehicle #1 would produce specific battery temperature vs. time, battery voltage vs. time, and battery current vs. time data for an average and severe driving sequence. Of course, the number of driving sequences used for each vehicle is limitless and therefore, the number of driving sequences performed can be limited to an amount that provides data that results in an accurate battery service life prediction from the battery life prediction algorithm.

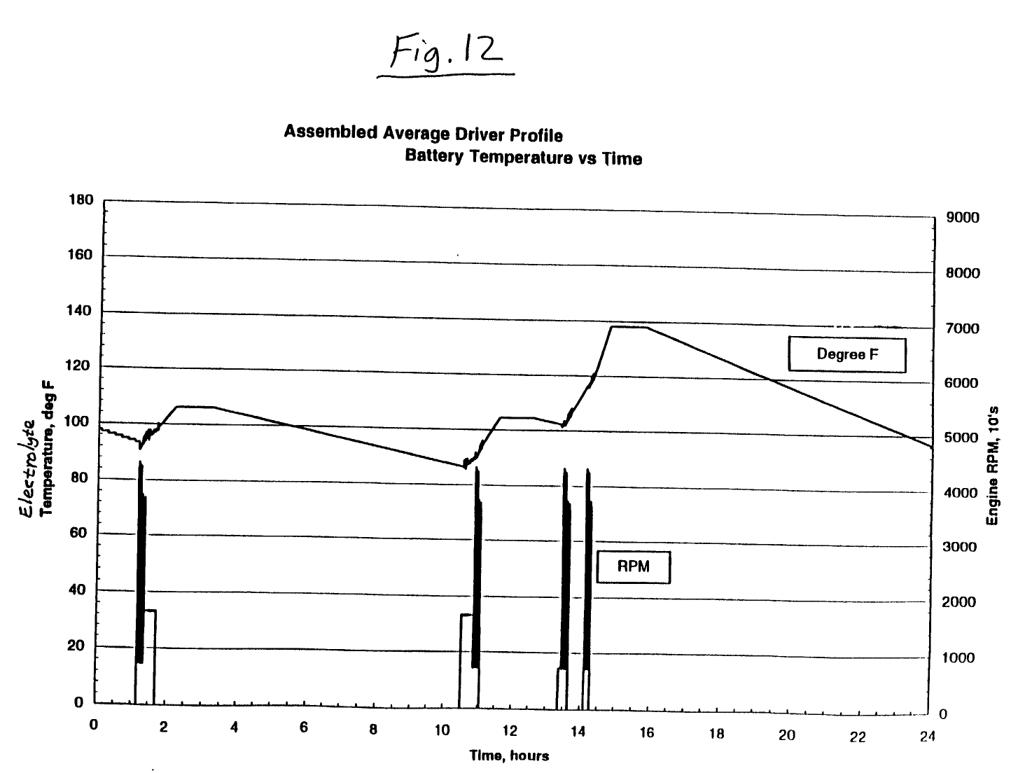

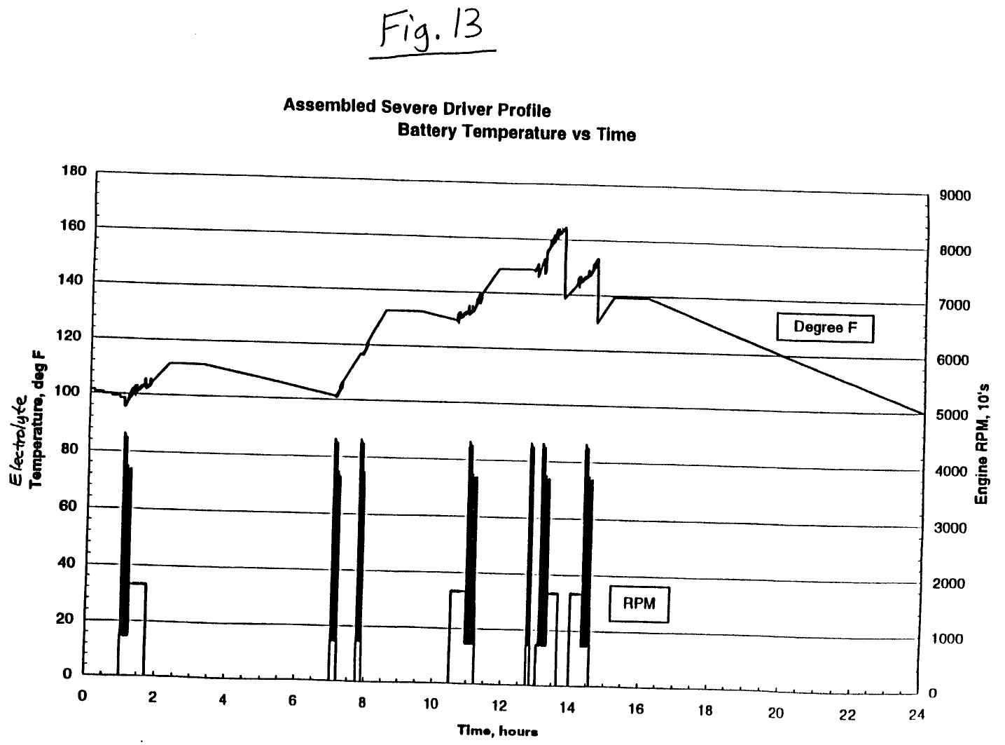

In another method for creating vehicle table 401 data, wind tunnel driving simulations can be used to obtain under the hood operating readings and these under the hood operating readings can be combined with data from transportation surveys to create battery temperature, voltage and current data for a typical one day operating period. Looking at FIGS. 12 and 13, there are shown battery temperature vs. time plots created using wind tunnel driving simulations and a widely available personal transportation survey. The battery temperature vs. time plots were created as follows. First, a vehicle battery was equipped with electrolyte temperature, battery voltage and battery current monitors that were connected to a data recorder. A wind tunnel was then used to simulate driving conditions and the battery temperature, voltage and current were recorded during the drive simulation. Next, the battery temperature, voltage and current data collected during the drive simulation were combined with data from the “Nationwide Personal Transportation Survey 1983 and 1990” which is commercially available from the U.S. Department of Transportation Bureau of Transportation Statistics (the “Transportation Survey”).

The data combination process begins by selecting a sample of drive habits from the Transportation Survey. In these drive habits, periods of engine on and engine off are noted. Next, the data recorded during engine on sequences during the wind tunnel simulation are matched up with periods of engine on in the drive habits from the Transportation Survey. Referring now to FIG. 12, the results of the data combination process are shown. In this example, an average drive pattern that included four engine on sequences was selected from the Transportation Survey. Wind tunnel data on battery temperature during engine on sequences and during a period of time after engine off was plotted at the engine on time periods of the drive pattern. Battery temperature between engine on time periods was then interpolated. The same data combination process was used to create FIG. 13 which shows battery temperature vs. time for a severe driving pattern with seven engine on time periods. This data construction technique can be used for any battery variable that can be monitored during wind tunnel driving simulation.

When a user selects a specific vehicle using the computer system as described above, the battery life prediction algorithm locates the specific vehicle in the vehicle table 401 and reads the corresponding vehicle data obtained during various vehicle operating conditions for use in the battery life prediction algorithm. It can be appreciated that by processing vehicle operating condition data in the battery life prediction algorithm, battery end-of-life predictions can be properly adjusted for severe driving conditions or vehicles having unfavorable under the hood operating environments.

### 3. Climate Variables

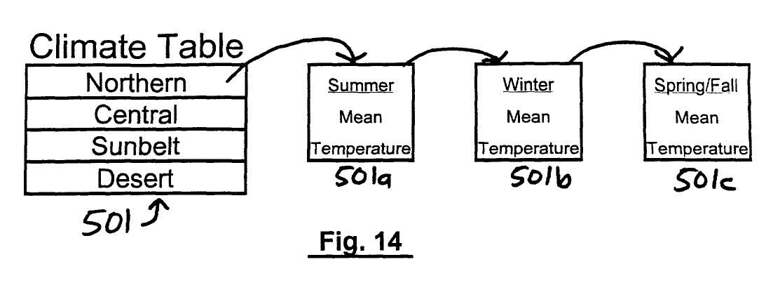

As detailed above, it has been reported that lead-acid vehicle battery life depends on the geographic region in which the vehicle (and the battery) are operated. Specifically, it is well known that increasing average mean temperature for a geographic region correlates with decreasing battery life. Accordingly, the battery life prediction algorithm used in the computer system of the present invention calculates battery end-of-life using values from the climate lookup table data structure shown in FIG. 14. It can be seen that the data structure includes a climate table 501 with an entry for various geographic regions in the United States. Each entry contains a pointer to a linked list of blocks 501a-501c containing the mean temperature for summer, winter and spring/fall in each of the geographic regions. The data in the climate table is publicly available from a number of sources.

When a user selects a specific geographic region using the computer system as described above, the battery life prediction algorithm locates the specific geographic region in the climate table 501 and reads the corresponding mean temperature data for use in the battery life prediction algorithm. It can be appreciated that by processing climate data in the battery life prediction algorithm, battery end-of-life predictions can be properly adjusted for severe climate conditions.

### B. End of Life Calculation in the Battery Life Prediction Algorithm

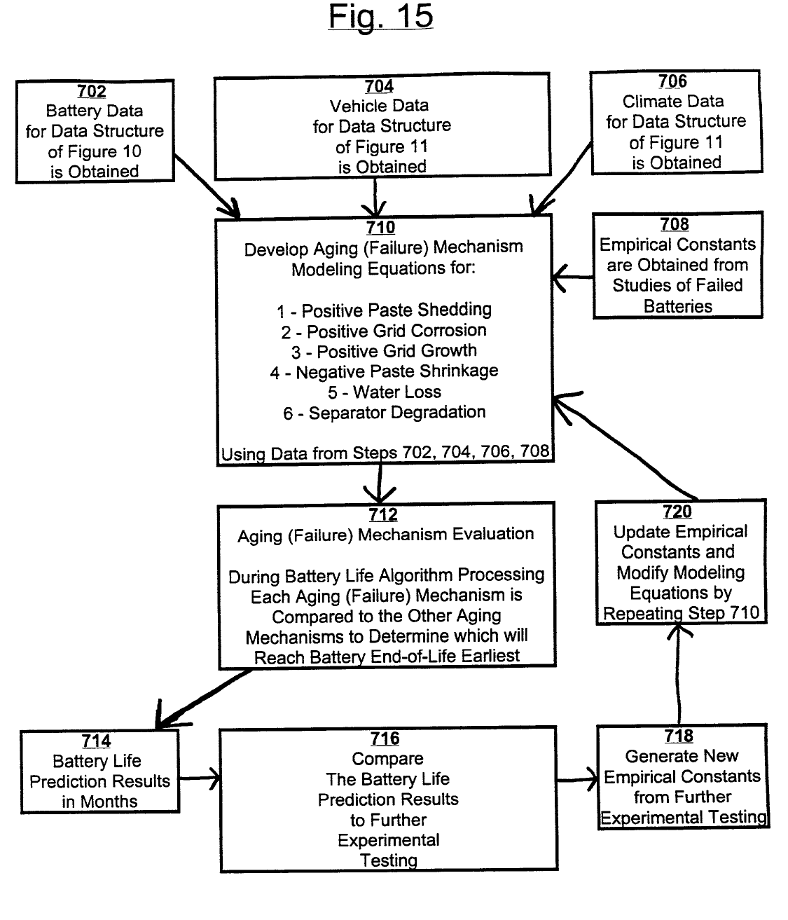

As discussed above, studies have identified typical failure mechanisms in a lead-acid battery. Major failure mechanisms include: positive paste shedding, positive grid corrosion, positive grid growth, negative paste shrinkage, water loss, and separator degradation. In the present invention, the battery life prediction algorithm concurrently models the progress of each of these failure mechanisms with respect to time and when the progress of one of the failure mechanisms reaches a point where battery failure would occur, the battery life prediction algorithm outputs a predicted life in months. Specifically, equations that model positive paste shedding, positive grid corrosion, positive grid growth, negative paste shrinkage, water loss, and separator degradation as a function of the battery design variables, the vehicle design and vehicle drive pattern variables, and the climate variables described above were developed. These equations can be prepared using the results of battery analysis techniques known to those in the battery field. An example of the steps used to develop a battery life prediction algorithm in accordance with the present invention is shown in FIG. 15.

First, at Step 702, battery data for the data structure shown in FIG. 10 is obtained as described above; at Step 704, vehicle data for the data structure shown in FIG. 11 is obtained as described above; and at Step 706 climate data for the data structure shown in FIG. 11 is obtained as described above. Next, at Step 708, empirical constants are developed for use in the battery aging (failure) mechanism modeling equations that are created in Step 710. The empirical constants are determined from battery analysis techniques undertaken at different times in the life of experimental batteries. At Step 710, the data from Steps 702, 704, 706 and 708 is used to develop battery aging (failure) mechanism modeling equations for the six battery failure mechanisms described above and noted in FIG. 15. These battery aging (failure) mechanism modeling equations are integrated into a battery life prediction algorithm that may be stored on any computer readable medium. At Step 712, the battery life prediction algorithm developed in Step 710 may executed in either of the operating environments 10 or 410 as described above or any equivalent operating environment. During processing of the battery life prediction algorithm, the algorithm concurrently models the progress of each of the aging (failure) mechanisms shown in Step 710 with respect to time and when the progress of one of the aging (failure) mechanisms reaches a point where battery failure would occur, the battery life prediction algorithm outputs at least one predicted battery life in months as shown at Step 714. In the version of the invention described herein, a battery life prediction is outputted for average and severe driving conditions as shown in FIG. 6.

At Step 716, a number of the battery life prediction results generated in Steps 712 and 714 may then be compared to the results of further experimental testing such as the testing described above. In certain circumstances, new empirical constants may be generated from the results of further experimental testing as shown at Step 718. If new empirical constants are generated, the empirical constants used in the battery aging (failure) mechanism modeling equations may be modified as shown at Step 720.

Therefore, it can be seen that a computer system for vehicle battery selection based on vehicle operating conditions has been disclosed. The computer system allows a user to obtain a prediction of vehicle battery service life when the user inputs a battery, a vehicle in which the battery will be installed and driving habits, and a geographic region in which the vehicle will be operated.

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. An automated system for predicting a life of any of a plurality of batteries, the automated system comprising:
a data entry system, the data entry system being programmed to allow a user to select:
a battery;
a vehicle;
a climate; and
a driving habit;
a computer communicatively coupled to the data entry system, the computer comprising:
a storage device, storing battery data, vehicle data, climate data, and driving habit data; and
a processing unit, the processing unit being programmed to receive the battery, vehicle, climate, and driving habit selections from the data entry system, retrieve corresponding data from the storage device, and to determine a life of the battery when used in the selected vehicle in the selected climate in the selected driving habit.

2. The automated system as defined in claim 1, wherein the battery data comprises a lookup table of battery construction data.

3. The automated system as defined in claim 1, wherein the vehicle data comprises a lookup table including at least one of a temperature versus time, a voltage versus time, and a current versus time.

4. The automated system as defined in claim 1, wherein the climate comprises a geographic region, and the climate data comprises corresponding seasonal and mean temperature data.

5. The automated system as defined in claim 1, wherein the data entry system is communicatively coupled to the computer through a computer network connection.

6. The automated system as defined in claim 5, wherein the network connection is a local area network.

7. The automated system as defined in claim 5, wherein the network connection is a wide area network.

8. The automated system as defined in claim 5, wherein the network connection is an internet link.

9. The automated system as defined in claim 1, wherein the computer and the data entry system comprise a kiosk.

10. The automated system as defined in claim 1, wherein the processing unit is programmed to model a plurality of failure modes for the battery, determine the most likely failure mode for the selected vehicle, climate, and driving habit, and determine an expected time to failure for this mode.

11. The automated system as defined in claim 10, wherein the plurality of failure modes includes at least two of a positive paste shedding failure, a positive grid corrosion failure, a positive grid growth failure, a negative paste shrinkage failure, a water loss failure, and a separator degradation failure.

12. The automated system as defined in claim 10, wherein the failure modes are determined based on empirical constants determined from battery failures.

13. The automated system as defined in claim 1, wherein the driving habit comprises an average and a severe driving habit.

14. The automated system as defined in claim 1, wherein the driving habit data comprises a lookup table of temperature versus time.

15. A computerized system for selecting a battery for use in a selected vehicle, operated in a selected climate, the computerized system comprising:
a communications network;
a first computer coupled to the communications network, the first computer being programmed to:
prompt a user to select a battery, a driving habit, and a vehicle; and
transmit the selected battery, driving habit, and vehicle through the communications network;
a second computer coupled to the communications network, the second computer being programmed to:
receive the battery, the vehicle, the climate, and the driving habit selection from the user;
calculate a life expectancy for the battery as a function of the selected vehicle, climate, and driving habit; and
transmit the calculated life expectancy to the first computer.

16. The computerized system as defined in claim 10, wherein the communications network comprises an internet link.

17. The computerized system as defined in claim 11, wherein the first and second computers each comprise an e-mail server.

18. The computerized system as defined in claim 10, wherein the selected vehicle determines an expected voltage draw versus time, and expected current draw versus time, and an expected temperature versus time.

19. The computerized system as defined in claim 10, wherein the selected climate determines an expected mean operational temperature for the battery.

20. A method for predicting the life of a battery, the method comprising the following steps:
modeling an aging mechanism for a battery, the aging mechanism for the battery being determined experimentally as a function of:
at least one empirical constant determined from a failed battery;
a plurality of battery construction parameters;
a temperature versus time;
a current versus time; and
a voltage versus time;
prompting a user to select a vehicle and a climate, the vehicle establishing the temperature, voltage, and current parameters versus time and the climate establishing an expected operating temperature;
modeling each of a plurality of failure modes as a function of the temperature, voltage, and current parameters, and determining which will cause failure;
calculating an expected life of the battery as a function of the expected failure mode; and
providing the expected life of the battery to the user.

21. The method as defined in claim 10, wherein the step of modeling the aging mechanism comprises the steps of obtaining empirical constants from failed batteries.
